(19) United States
(12) Patent Application Publication
(10) Pub. No.: US 2026/0321972 A1
(43) Pub. Date: Oct. 15, 2026

(54) APPARATUS COMPRISING TWO ANTENNA SYSTEMS AND A METHOD FOR PROVIDING AN APPARATUS COMPRISING TWO ANTENNA SYSTEMS

(71) Applicant: Nokia Solutions and Networks Oy, Espoo (FI)

(72) Inventors: Risto Pekka VALKONEN, Espoo (FI); Juha Olli JOKILAHTI, Espoo (FI)

(21) Appl. No.: 19/538,717

(22) Filed: Feb. 12, 2026

(30) Foreign Application Priority Data
Feb. 19, 2025 (FI) 20255148

(51) Int. Cl. H01Q 1/52; H01Q 1/42; H01Q 9/04

(52) U.S. Cl. CPC H01Q 1/521; H01Q 1/42; H01Q 9/0407

(57) ABSTRACT

An apparatus comprising a first antenna system, a second antenna system, a first isolation structure arranged between the first antenna system and the second antenna system for suppressing a propagation of electromagnetic waves between the first antenna system and the second antenna system, and a second isolation structure arranged between the first antenna system and the second antenna system for suppressing a propagation of electromagnetic waves between the first antenna system and the second antenna system, wherein the second isolation structure is arranged at least partially over the first isolation structure.

### FIELD OF THE DISCLOSURE

Various example embodiments relate to an apparatus comprising two antenna systems.

Further example embodiments relate to a method for providing an apparatus comprising two antenna systems.

### BACKGROUND

Antenna Systems may be used to exchange signals for wireless communication. For some applications, an electromagnetic isolation between antennas may be desired.

### SUMMARY

Various example embodiments of the disclosure are set out by the independent claims. The example embodiments and features, if any, described in this specification, that do not fall under the scope of the independent claims, are to be interpreted as examples useful for understanding various example embodiments of the disclosure.

Some examples relate to an apparatus comprising a first antenna system, a second antenna system, a first isolation structure arranged between the first antenna system and the second antenna system for suppressing a propagation of electromagnetic waves between the first antenna system and the second antenna system, and a second isolation structure arranged between the first antenna system and the second antenna system for suppressing a propagation of electromagnetic waves between the first antenna system and the second antenna system, wherein the second isolation structure is arranged at least partially over the first isolation structure. In some examples, this enables to provide an improved electromagnetic isolation between the first antenna system and the second antenna system.

In some examples, at least one of the first antenna system or the second antenna system comprises or represents at least one of: a) an antenna, for example, a single antenna, or b) a plurality of antennas, for example, in the form of an antenna array.

In some examples, the electromagnetic waves that may be suppressed using the isolation structures according to the disclosure may comprise at least one of: a) surface waves, or b) free space waves.

In some examples, the first isolation structure is an electronic band gap, EBG, structure, which, for example, provides at forbidden frequency band wherein the electromagnetic waves do not propagate.

In some examples, the first isolation structure may, for example, comprise a plurality of unit cells arranged in a two-dimensional grid having a first periodicity along a first dimension, for example, along a longitudinal axis between the first and second antenna systems, wherein at least some unit cells comprise a ground plane, a dielectric substrate, a top metallic patch, and a connecting element (for example, a plated-through via) connecting the top metallic patch with the ground plane.

In some examples, the first isolation structure may comprise a configuration as disclosed in D. Sievenpiper, Lijun Zhang, R. F. J. Broas, N. G. Alexopolous and E. Yablonovitch, “High-impedance electromagnetic surfaces with a forbidden frequency band,” in IEEE Transactions on Microwave Theory and Techniques, vol. 47, no. 11, pp. 2059-2074, November 1999, doi: 10.1109/22.798001, which may be referred to a “mushroom-type EBG”.

In some examples, at least one support structure may be provided for supporting at least one of the following elements: a) the first antenna system, or b) the second antenna system, or c) the first isolation structure, or d) the second isolation structure.

In some examples, a common support structure may be provided for supporting at least two of the following elements: a) the first antenna system, or b) the second antenna system, or c) the first isolation structure, or d) the second isolation structure.

In some examples, the first isolation structure is a) arranged on a surface of a support structure (for example, individual support structure or a common support structure) or b) at least partially integrated into the support structure.

In some examples, the second isolation structure comprises a plurality of strips of electrically conductive material. In some examples, this enables to provide a configuration of first and second isolation structures comprising a comparatively low profile.

In some examples, at least some of the strips of the second isolation structure are arranged in parallel to each other.

In some examples, a distance between adjacent strips may, for example, be less than a wavelength, for example, free-space wavelength, of the electromagnetic waves to be suppressed by the first and second isolation structures, for example, less than 50 percent of the wavelength, for example, less than one eighth of the wavelength.

In some examples, a periodicity of at least some of the strips may be different from a periodicity of the EBG unit cells of the first isolation structure according to some examples.

In some examples, at least some of the strips of the second isolation structure are straight, which may enable a particularly efficient manufacturing.

In some examples, at least some of the strips are oriented at an angle of 30 degrees or more relative to a longitudinal axis along which both antenna systems are positioned, for example, on a, for example common, support structure. In some examples, this enables to provide a particularly efficient electromagnetic isolation between the first antenna system and the second antenna system, for example, by reducing an H-plane coupling between the first antenna system and the second antenna system.

In some examples, at least some of the strips are oriented at an angle of 45 degrees or more relative to the longitudinal axis. In some examples, at least some of the strips may, for example, be oriented at least substantially perpendicular to the longitudinal axis.

In some examples, the second isolation structure comprises at least two layers, each of the at least two layers comprising a respective plurality of strips of electrically conductive material.

In some examples, at least some of the strips of a first layer of the at least two layers are oriented at a first angle of +30 degrees or more relative to the longitudinal axis along which both antenna systems are arranged, for example, positioned on a respective individual or common support structure, wherein at least some of the strips of a second layer of the at least two layers are oriented at a second angle different from the fist angle relative to the longitudinal axis. In some examples, the second angle may, for example, be equal to or less than −30 degrees or less relative to the longitudinal axis. In some examples, the first angle may, for example, be +45 degrees, and the second angle may, for example, be −45 degrees.

In some examples, at least some of the strips are curved.

In some examples, at least some of the strips comprise a plurality of curved sections with at least two different radii of curvature.

In some examples, at least some of the strips are S-shaped.

In some examples, a first number of strips are straight, wherein one or more other strips, for example, a second number of one or more other strips, are not straight, but, for example, curved, for example, S-shaped.

In some examples, at least some of the strips are S-shaped, wherein at least some other strips comprise a mirrored S-shape. In some examples, at least some of the S-shaped strips may be provided in a first layer, for example, on a first surface of a support structure for the second isolation structure, and at least some of the mirrored S-shaped strips may be provided in a second layer, for example, on a second surface of the support structure for the second isolation structure.

In some examples, at least some of the strips comprise a length of 50 percent of a free-space wavelength of the electromagnetic waves or less. Note that in some examples this example length criterion may apply to any shape (for example, curved, for example, S-shaped) of the strips according to the disclosure and is, for example, not limited to straight strips.

In some examples, at least two of the strips are collinear and spaced apart by a first distance, wherein for example the first distance is equal to or less than one eighth of the wavelength of the electromagnetic waves.

In some examples, a distance between the first isolation structure and the second isolation structure, for example, as measured from a top surface of the first isolation structure to a bottom surface of the electrically conductive strips facing the top surface of the first isolation structure, for example, along surface normal vector of support structure, is less than 33 percent of a wavelength, for example, free-space wavelength, for example, less than 25 percent of the wavelength, of the electromagnetic waves. In some examples, this enables to provide a particularly low-profile isolation arrangement comprising the two isolation structures.

In some examples, a frequency of the electromagnetic waves to be suppressed by the isolation structures according to the disclosure may, for example, range between 1 GHz and 28 GHz, for example, between 6 GHz and 10 GHz, for example, about 7 GHz. In some examples, this corresponds with wavelengths, for example, free-space wavelengths between 0.3 m and 0.011 m, for example, between 0.05 m and 0.03 m, for example, about 0.043 m.

Insofar, for the example wavelength of about 0.043 m, associated with a frequency of about 7 GHz, a distance between the first isolation structure and the second isolation structure may, for example, be less than 33 percent of a wavelength, for example, free-space wavelength, of the electromagnetic waves, for example, less than about 14.2 millimeters, mm.

Note however, that in some other examples, other frequency ranges and associated wavelength ranges are also possible.

In some examples, a distance between the first isolation structure and the second isolation structure may, for example, be equal to or greater than 1 mm.

In some examples, at least one of the first antenna system or the second antenna system is a dual-polarized antenna system.

In some examples, the first isolation structure and the second isolation structure are configured to reduce, for example, jointly, reduce, an H-plane coupling and an E-plane coupling between the first antenna system and the second antenna system. According to Applicant's analysis, the combination of the first isolation structure with the second isolation structure enables to provide an increased electromagnetic isolation as compared to some conventional approaches, which, in some examples, also reduces a, for example per se undesired, H-plane coupling between the first antenna system and the second antenna system.

In some examples, the first isolation structure is provided on a first support structure, for example, carrier and the second isolation structure is provided on a second support structure, for example, carrier, for example, different from the first support structure, for example, carrier. In other words, in some examples, it is possible to provide individual support structures or carriers for the respective first and second isolation structures. In some examples, the first carrier and the second carrier may be spaced apart from each other with a predetermined distance, wherein a distance of the first isolation structure and the second isolation structure may be controlled.

In some examples, the second carrier may, for example, form a radome for at least some components of the apparatus.

In some examples, at least one of the first support structure and the second support structure may comprise at least one of: a) a substrate, for example, ceramic carrier, or b) a printed circuit board, PCB, for example, a multi-layer PCB.

In some examples, however, it is also possible that the first isolation structure and the second isolation structure are both provided on a same support structure, for example, carrier.

In some examples, wherein, for example, a common support structure for at least two components is provided, for example, a common support structure for the first antenna system and the second antenna system, at least one of the first isolation structure and the second isolation structure may be provided on the common support structure.

In some examples, a radome may be provided, the radome, for example, covering at least one component of the apparatus, such as, for example, at least one of the antenna systems, and/or at a portion of the first isolation structure. In some examples, the second isolation structure may be arranged on the radome, for example, on an inner surface and/or an outer surface of the radome. In some other examples, however, it is also possible to arrange the second isolation structure at least partly within the radome.

In some examples, an aggregated height of the first isolation structure and the second isolation structure is less than 10 millimeters, for example less than about 5 mm. In some examples, this enables to provide a particularly low-profile aggregated isolation structure.

Some examples relate to a device for a wireless communication system comprising at least one apparatus according to the disclosure.

In some examples, the device may, for example, comprise or represent at least one of: a) base station, for example, eNB or gNB, or b) an access node, or c) a router, or d) a remote radio head.

Some examples relate to a method for providing an apparatus comprising a first antenna system and a second antenna system, the method comprising: providing a first isolation structure between the first antenna system and the second antenna system for suppressing a propagation of electromagnetic waves between the first antenna system and the second antenna system, providing a second isolation structure between the first antenna system and the second antenna system for suppressing a propagation of electromagnetic waves between the first antenna system and the second antenna system by arranging the second isolation structure at least partially over the first isolation structure.

In some examples, providing the second isolation structure comprises at least one of: a) applying electrically conductive ink to a carrier forming a plurality of electrically conductive strips on the carrier, or b) forming a plurality of electrically conductive strips on the carrier using laser structuring, or c) forming a plurality of electrically conductive strips on the carrier using a molded interconnected device, MID, manufacturing technique.

### BRIEF DESCRIPTION OF THE FIGURES

FIG. 1 depicts a simplified top view,

FIG. 2 depicts a simplified top view,

FIG. 3A depicts a simplified top view,

FIG. 3B depicts a simplified side view,

FIG. 4 depicts a simplified top view,

FIG. 5 depicts details of aspects of FIG. 4,

FIG. 6 depicts a simplified top view,

FIG. 7 depicts a simplified side view,

FIG. 8A depicts a simplified top view,

FIG. 8B depicts a simplified bottom view,

FIG. 9 depicts a simplified top view,

FIG. 10 depicts a simplified top view,

FIG. 11 depicts a simplified top view,

FIG. 12 depicts a simplified top view,

FIG. 13 depicts a simplified top view,

FIG. 14A depicts a simplified top view,

FIG. 14B depicts a simplified top view,

FIG. 14C depicts a simplified top view,

FIG. 15 depicts a simplified side view,

FIG. 16 depicts a simplified side view,

FIG. 17 depicts a simplified side view,

FIG. 18 depicts a simplified side view,

FIG. 19 depicts a simplified block diagram,

FIG. 20A depicts a simplified flow-chart,

FIG. 20B depicts a simplified flow-chart,

FIG. 21A depicts a simplified top view of a conventional apparatus having two antenna systems,

FIG. 21B depicts a simplified top view of an apparatus according to some examples,

FIG. 22A depicts a coloured illustration of an electric field strength for the conventional apparatus of FIG. 21A,

FIG. 22B depicts a coloured illustration of an electric field strength for the apparatus of FIG. 21B,

FIG. 23A depicts a black and white version of the illustration of FIG. 22A,

FIG. 23B depicts a black and white version of the illustration of FIG. 22B,

FIG. 24A depicts scattering parameters over a frequency range according to some examples,

FIG. 24B depicts scattering parameters over a frequency range according to some examples.

### DESCRIPTION OF SOME EXAMPLE EMBODIMENTS

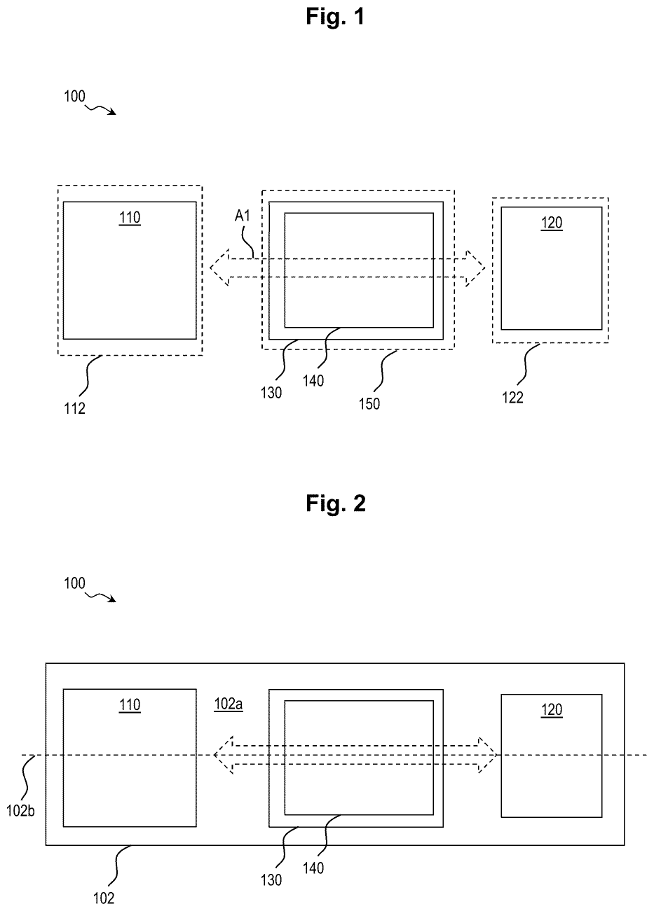

Some examples, see, for example, FIGS. 1, 2, relate to an apparatus 100 comprising a first antenna system 110 and a second antenna system 120. A first isolation structure 130 for suppressing a propagation of electromagnetic waves A1 between the first antenna system 110 and the second antenna system 120 is arranged between the first antenna system 110 and the second antenna system 120. Additionally, a second isolation structure 140 is provided, which is also arranged between the first antenna system 110 and the second antenna system 120, for suppressing the propagation A1 of electromagnetic waves between the first antenna system 110 and the second antenna system 120. The second isolation structure 140 is arranged at least partially over the first isolation structure 130. In some examples, this enables to provide an improved electromagnetic isolation between the first antenna system 110 and the second antenna system 120.

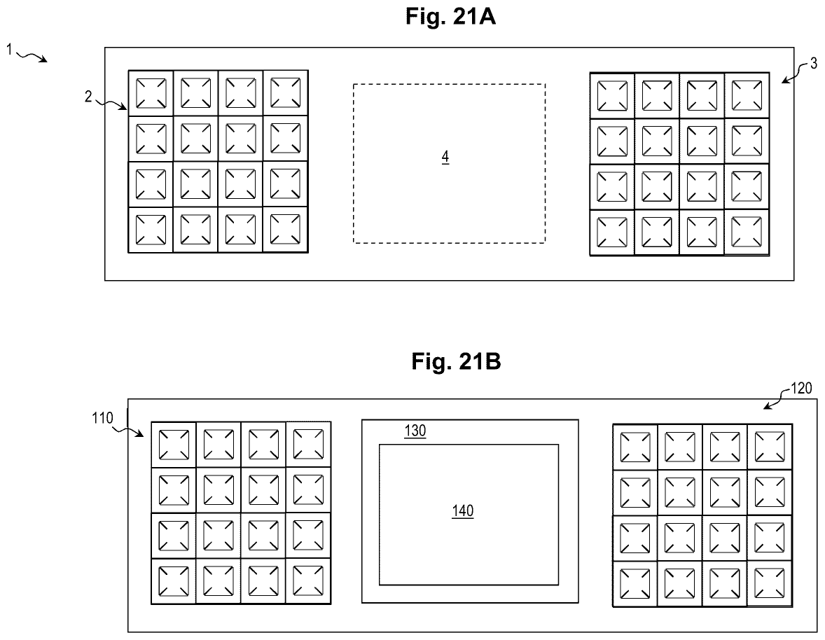

In some examples, FIG. 1, at least one of the first antenna system 110 or the second antenna system 120 comprises or represents at least one of: a) an antenna, for example, a single antenna, or b) a plurality of antennas, for example, in the form of an antenna array (also see FIG. 21B).

In some examples, FIG. 1, the electromagnetic waves A1 that may be suppressed using the isolation structures 130, 140 according to the disclosure may comprise at least one of: a) surface waves, or b) free space waves.

In some examples, FIG. 1, at least one of the components 110, 120, 130, 140 may be provided on a respective support structure, for example, a carrier. As an example, the first antenna system 110 may be provided on a first carrier 112, the second antenna system 120 may be provided on a second carrier 122, and at least one of the isolation structures 130, 140 may be provided on at least one further carrier 150.

In some other examples, however, see FIG. 2, a common support structure, for example carrier, 102 may be provided, wherein at least one of the components 110, 120, 130, 140 is arranged on a first surface 102a of the common carrier 102. As an example, the first and second antenna systems 110, 120 are arranged along a longitudinal axis 102b of the common carrier 102, and the isolation structures 130, 140 are provided between the first and second antenna systems 110, 120.

In some examples, FIG. 2, the common carrier 102 may form a common ground plane.

In some examples, FIGS. 1, 2, the first isolation structure 130 is an electronic band gap, EBG, structure, which, for example, provides a forbidden frequency band wherein the electromagnetic waves A1 do not propagate.

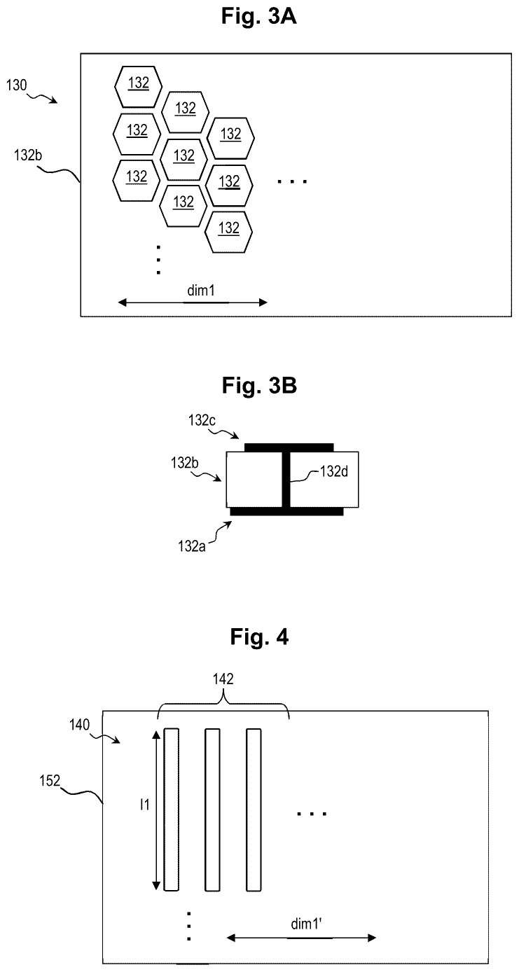

In some examples, FIG. 3A, the first isolation structure 130 may, for example, comprise a plurality of unit cells 132 arranged in a two-dimensional grid having a first periodicity along a first dimension dim1, for example, along the longitudinal axis 102b (FIG. 2), between the first and second antenna systems 110, 120. FIG. 3B schematically depicts a side view of one unit cell 132. As can be seen, the unit cell 132 may comprise a ground plane 132a, a dielectric substrate 132b, a top metallic patch 132c, and a connecting element, for example, a plated-through via, 132d connecting the top metallic patch 132c with the ground plane 132a, see the schematic side view of FIG. 3B.

In some examples, FIGS. 3A, 3B, the first isolation structure 130 may comprise a configuration at least similar to the above-mentioned mushroom-type EBG.

In some examples, FIGS. 3A, 3B, the dielectric substrate 132b may form a support structure for the first isolation structure 130, wherein at least some components 132a, 132c of the first isolation structure 130 are arranged on respective surfaces of the dielectric substrate 132b, and wherein at least one component, presently for example the connecting element 132d, is at least partially integrated into the support structure 132b.

In some examples, FIG. 4, the second isolation structure 140 comprises a plurality 142 of strips of electrically conductive material, presently, for example, arranged on a dielectric carrier 152. In some examples, this enables to provide a configuration of first and second isolation structures 130, 140 comprising a comparatively low profile, for example, small height.

In some examples, FIG. 4, at least some of the strips of the second isolation structure 140 are arranged in parallel to each other, for example, arranged along a horizontal coordinate in FIG. 4, also see the double arrow dim1′, which, in some examples, may, for example, correspond with the first dimension dim1 of the first isolation structure 130 according to FIG. 3A.

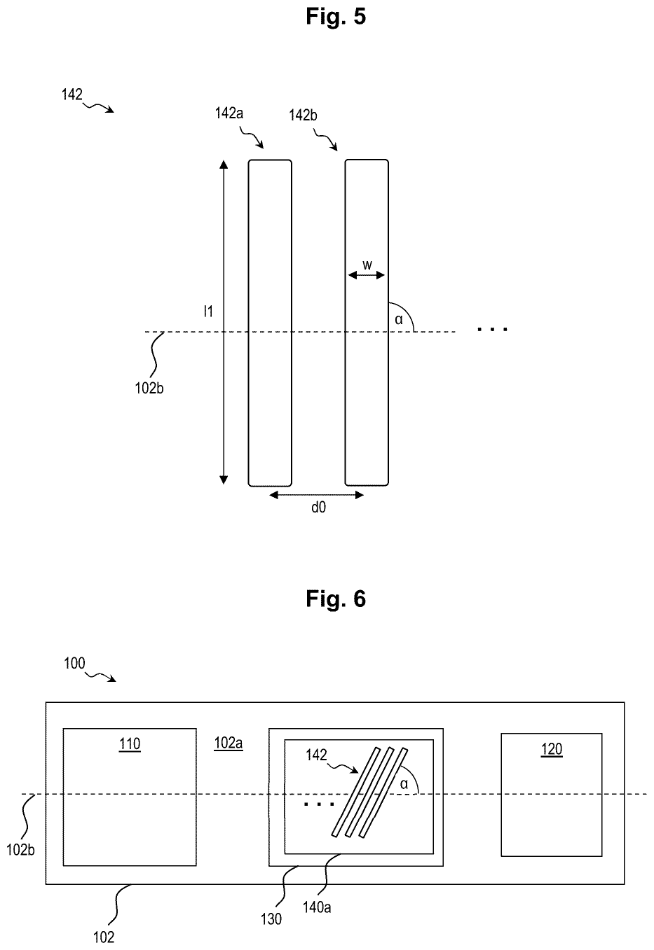

In some examples, see the detail view of FIG. 5, a distance d0 between adjacent strips 142a, 142b may, for example, be less than a wavelength, for example, free-space wavelength, of the electromagnetic waves A1 (FIG. 1) to be suppressed by the first and second isolation structures 130, 140, for example, less than 50 percent of the wavelength, for example, less than one eighth of the wavelength.

In some examples, FIG. 5, at least some of the strips 142a, 142b, . . . comprise a length l1 of 50 percent of a free-space wavelength of the electromagnetic waves or less.

In some examples, FIG. 5, at least some of the strips 142a, 142b, . . . may have a width w of 3 mm or less, for example, 1 mm or less. In some examples, a width w within a range of 0.5 mm to 1 mm may, for example, be used for frequencies of the electromagnetic waves A1 of 7 GHz. In some examples, the width w within the range of 0.5 mm to 1 mm may be used for frequencies of the electromagnetic waves A1 ranging from 5 GHz to 10 GHz.

In some examples, FIG. 5, a periodicity of at least some of the strips 142a, 142b, . . . , as, for example, characterized by the distance or spacing d0 between adjacent strips 142a, 142b, may be different from a periodicity of the EBG unit cells 132 (for example, along the first dimension dim1, FIG. 3A) of the first isolation structure 130 according to some examples.

In some examples, FIGS. 4, 5, at least some of the strips 142a, 142b, . . . of the second isolation structure 140 are straight, which may enable a particularly efficient manufacturing.

In some examples, FIG. 6, a variant 140a of the second isolation structure is depicted, wherein at least some of the plurality 142 of strips are oriented at an angle α of 30 degrees or more relative to a longitudinal axis 102b along which both antenna systems 110, 120 are positioned, for example, on a, for example common, support structure 102a. In some examples, this enables to provide a particularly efficient electromagnetic isolation between the first antenna system 110 and the second antenna system 120, for example, by reducing an H-plane coupling between the first antenna system 110 and the second antenna system 120.

In some examples, FIG. 6, at least some of the strips 142 are oriented at an angle α of 45 degrees or more relative to the longitudinal axis.

In some examples, FIGS. 4, 5, at least some of the strips 142 may, for example, be oriented at least substantially perpendicular to the longitudinal axis 102b, for example, α=90°.

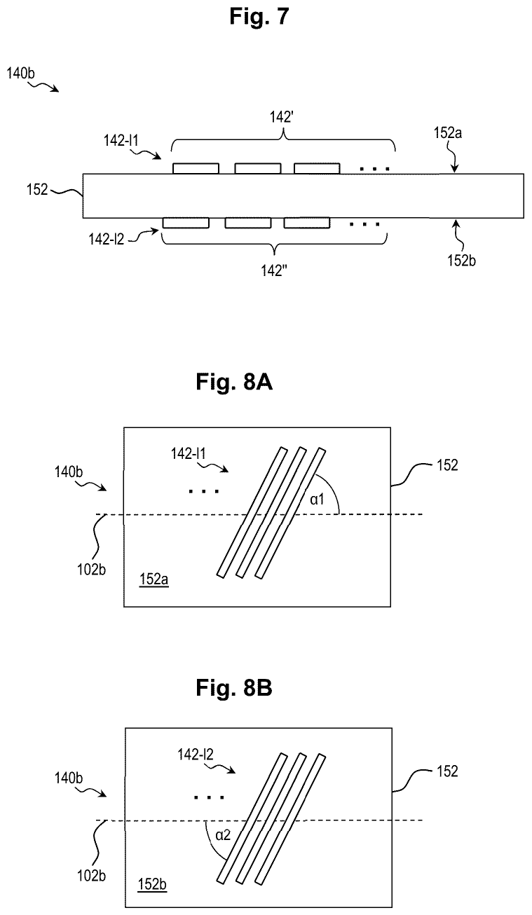

In some examples, FIG. 7, a variant 140b of the second isolation structure comprises at least two layers 142-l1, 142-l2, each of the at least two layers 142-l1, 142-l2 comprising a respective plurality 142′, 142′′ of strips of electrically conductive material. In some examples, a first layer 142-l1 of the at least two layers 142-l1, 142-l2 may be formed on a first surface 152a of the carrier 152, and a second layer 142-l2 of the at least two layers 142-l1, 142-l2 may be formed on a second, for example, opposite, surface 152b of the carrier 152.

In some examples, FIG. 8A, at least some of the strips of the first layer 142-l1 are oriented at a first angle α1 of +30 degrees or more relative to the longitudinal axis 102b along which both antenna systems 110, 120 (FIG. 2) are arranged, for example, positioned on a respective individual or common support structure, wherein at least some of the strips of the second layer 142-l2, see FIG. 8B, are oriented at a second angle α2 different from the first angle α1 relative to the longitudinal axis 102b. In some examples, the second angle α2 may, for example, be equal to or less than −30 degrees or less relative to the longitudinal axis 102b.

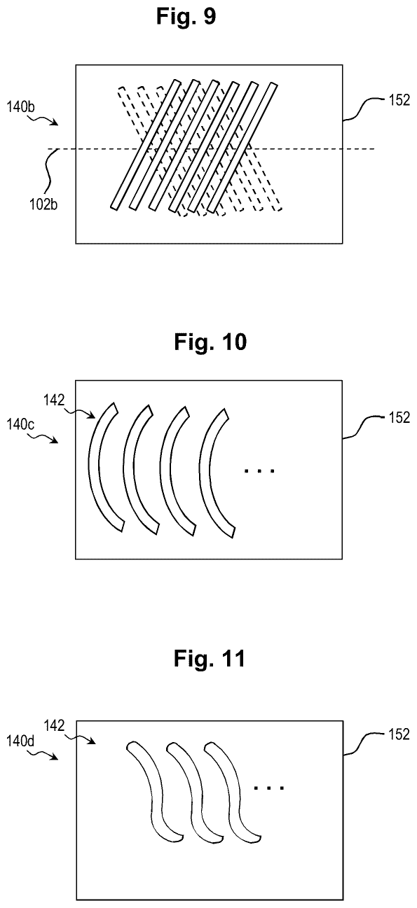

In some examples, the first angle α1 may, for example, be +45 degrees, and the second angle α2 may, for example, be −45 degrees, such that, in some examples, in projection, the strips of the two layers 142-l1, 142-l2 form aggregated X-shapes, see FIG. 9. In some examples, angles other than +45 degrees and −45 degrees may also be used to form X-shapes.

In some examples, FIG. 10, see the variant 140c of the second isolation structure, at least some of the plurality 142 of strips are curved, i.e., not straight.

In some examples, FIG. 11, see the variant 140d of the second isolation structure, at least some of the plurality 142 of strips comprise a plurality of curved sections with at least two different radii of curvature.

In some examples, see variant 140e of FIG. 12, at least some of the plurality 142 of strips are S-shaped.

In some examples, see variant 140f of FIG. 13, a first number 142-1 of strips are straight, wherein one or more other strips, for example, a second number 142-2 of one or more other strips, are not straight, but, for example, curved, for example, S-shaped.

In some examples (not shown), at least some of the plurality 142 of strips of the second isolation structure are S-shaped, wherein at least some other strips of the plurality 142 of strips comprise a mirrored S-shape. In some examples, at least some of the S-shaped strips (see, for example, FIG. 12) may be provided in a first layer 142-l1 (see, for example, FIG. 7), for example, on a first surface 152a of the carrier 152, and at least some of the mirrored S-shaped strips (not shown) may be provided in a second layer 142-l2, for example, on a second surface 152b of the carrier 152.

In some examples, see, for example, FIG. 4 et seq., at least some of the strips 142a, 142b, . . . comprise a length l1 of 50 percent of a free-space wavelength of the electromagnetic waves or less. Note that in some examples this example length criterion may apply to any shape (for example, curved, for example, S-shaped) of the strips according to the disclosure and is, for example, not limited to straight strips.

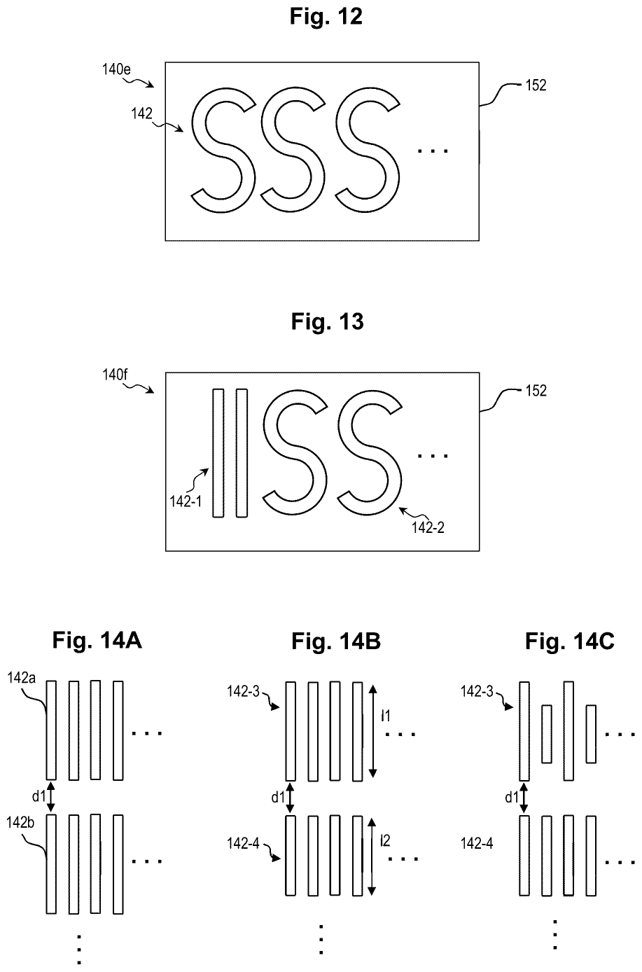

In some examples, FIG. 14A, at least two of the strips 142a, 142b are collinear and spaced apart by a first distance d1, wherein for example the first distance d1 is equal to or less than one eighth of the wavelength of the electromagnetic waves A1. In the example of FIG. 14A, the strips 142a, 142b, . . . are arranged in two rows, spaced apart by the first distance d1. In some other examples, however, more than two rows (not shown) of strips may be provided.

In some examples, FIG. 14B, it is possible to provide at least two rows of strips where one row has strips 142-3 of a first dimension (for example, length l1) and the other row has strips 142-4 of a second dimension, for example length l2, different to the first dimension. In the present example of FIG. 14B, the second length l2 is smaller than the first length l1, l2<l1. In some examples, this may enable to increase a bandwidth for suppression of the electromagnetic waves.

FIG. 14C depicts aspects of further examples, wherein different strips within the same row have different lengths. In some examples, as shown in FIG. 14C, this may apply to at least one row of strips; in other examples (not shown), it may apply to more than one row. In other words, in some cases (not shown), different strips in multiple rows may have different lengths.

In some examples, for example, in case of antenna arrays 110, 120, a number of rows of strips may, for example, depend on a number of the elements of the antenna arrays. As an example, if at least one of the antenna systems 110, 120 comprises a 4×4 array of antenna elements, in some examples (not shown) four rows of strips may be provided, wherein, for example, at least one the rows may be aligned with a respective row of, for example, four antenna elements.

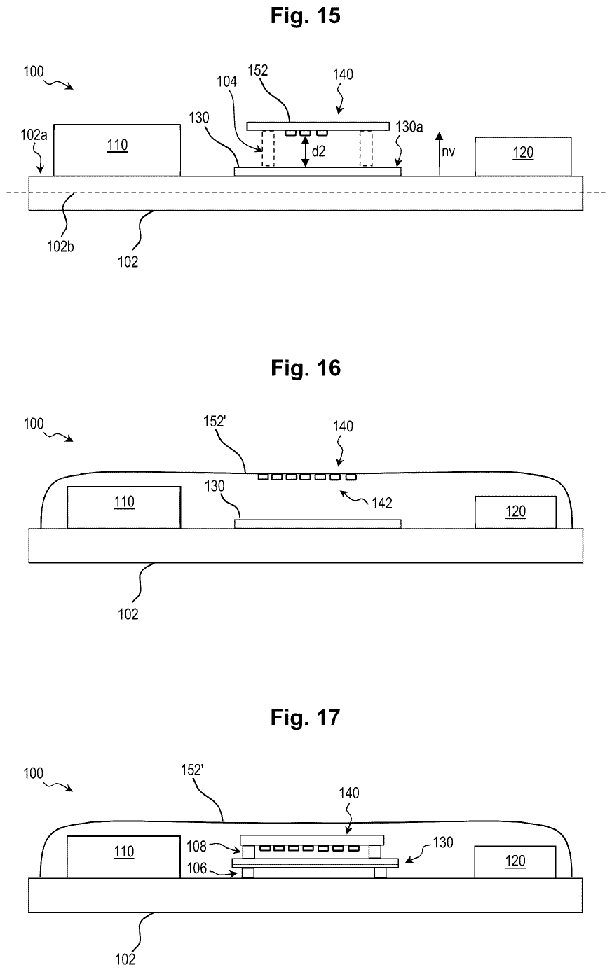

In some examples, see the schematic side view of FIG. 15, a distance d2 between the first isolation structure 130 and the second isolation structure 140, for example, as measured from a top surface 130a of the first isolation structure 130 to a bottom surface of the electrically conductive strips facing the top surface 130a of the first isolation structure 130, for example, along a surface normal vector nv of the support structure 102a, is less than 33 percent of a wavelength, for example, free-space wavelength, for example, less than 25 percent of the wavelength, of the electromagnetic waves. In some examples, this enables to provide a particularly low-profile isolation arrangement comprising the two isolation structures 130, 140.

In some examples, FIG. 15, a frequency of the electromagnetic waves to be suppressed by the isolation structures 130, 140 according to the disclosure may, for example, range between 1 GHz and 28 GHz, for example, between 6 GHz and 10 GHz, for example, about 7 GHz. In some examples, this corresponds with wavelengths, for example, free-space wavelengths between 0.3 m and 0.011 m, for example, between 0.05 m and 0.03 m, for example, about 0.043 m.

Insofar, for the example wavelength of about 0.043 m, associated with a frequency of about 7 GHz, a distance d2 (FIG. 15) between the first isolation structure 130 and the second isolation structure 140 may, for example, be less than 33 percent of a wavelength, for example, free-space wavelength, of the electromagnetic waves, for example, less than about 14.2 millimeters, mm. In this context, it is to be noted that the schematic side view of FIG. 15 is not drawn to scale. This also applies to other schematic views of the Figures according to the disclosure.

In some examples, FIG. 15, the distance d2 between the first isolation structure 130 and the second isolation structure 140 may, for example, be equal to or greater than 1 mm.

In some examples, one or more spacers 104 may be provided to maintain the distance d2 between the isolation structures 130, 140. In some examples, this may enable ensuring comparatively tight mechanical tolerances, which can be important, for example, at comparatively high frequency bands to maintain consistent electrical performance. In such examples, special materials with precise mechanical properties may be used.

In some examples, FIG. 15, at least one of the first antenna system 110 or the second antenna system 120 is a dual-polarized antenna system. In some other examples, one or more single-polarized antenna systems are also possible.

In some examples, FIG. 15, the first isolation structure 130 and the second isolation structure 140 are configured to reduce, for example, jointly reduce, an H-plane coupling and an E-plane coupling between the first antenna system 110 and the second antenna system 120.

According to Applicant's analysis, the combination of the first isolation structure 130 with the second isolation structure 140 enables to provide an increased electromagnetic isolation as compared to some conventional approaches. Particularly, the configuration according to the disclosure may contribute to reduce a, for example per se undesired, H-plane coupling between the first antenna system 110 and the second antenna system 120.

In some examples, FIG. 15, the first isolation structure 130 is provided on a first support structure, for example, a carrier, such as, for example, the common carrier 102, and the second isolation structure is provided on a second support structure 152, for example, carrier, for example, different from the first support structure, for example, carrier 102. In other words, in some examples, FIG. 15, it is possible to provide individual support structures or carriers 102, 152, respectively, for the respective first and second isolation structures 130, 140. As already mentioned above, in some examples, the first carrier 102 and the second carrier 152 may be spaced apart from each other with a predetermined distance d2, for example, by using one or more spacers sp, wherein the distance d2 between the first isolation structure 130 and the second isolation structure 140 may be controlled.

In some examples, FIG. 16, the second carrier 152′ may, for example, form a radome for at least some components 110, 120, 130, 140 of the apparatus. As can be seen from FIG. 16, in some examples, the plurality 142 of strips of the second isolation structure 140 may be arranged on an interior surface of the radome 152′.

FIG. 17 schematically depicts a side view according to further examples, wherein the strips of the second isolation structure 140 are not arranged on a surface of the radome 152′, in contrast to the configuration of FIG. 16. Rather, in the configuration of FIG. 17, the first isolation structure 130 is attached to the carrier 102 at a non-vanishing first vertical distance using spacers 106. The second isolation structure 140 is attached to the first isolation structure 130 at a non-vanishing second vertical distance using spacers 108.

In some examples, at least one of the first support structure 102 (FIGS. 2), 132b (FIG. 3B) and the second support structure 152 (FIG. 4) may comprise at least one of: a) a substrate, for example, ceramic carrier, or b) a printed circuit board, PCB, for example, a multi-layer PCB. In some examples, for example, in cases where the support structure forms a radome, see FIGS. 16, 17, the support structure may comprise a plastic, for example, polymeric, material.

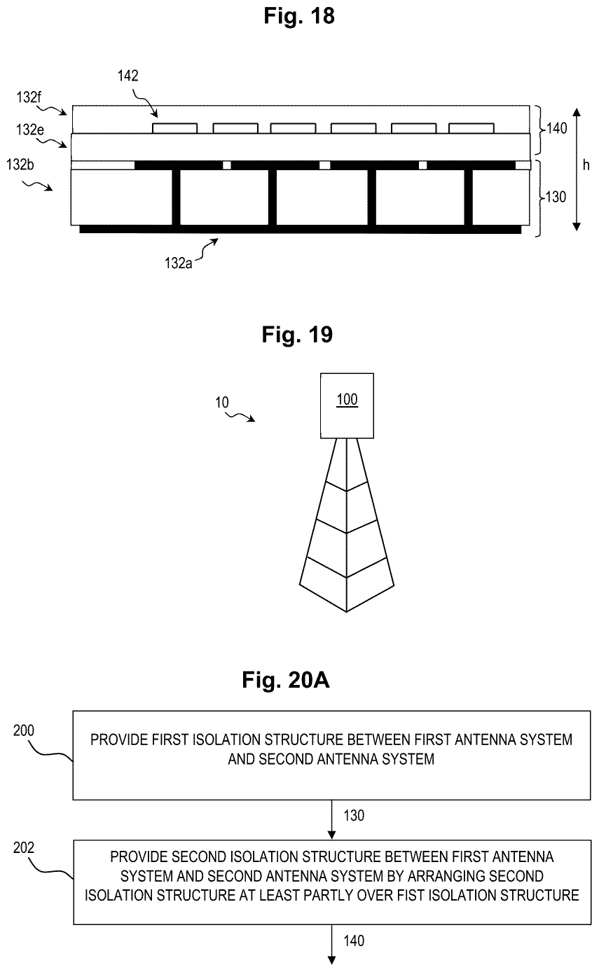

In some examples, it is possible that the first isolation structure 130 and the second isolation structure 140 are both provided on a same support structure, for example, carrier, see the schematic side view of FIG. 18. In some examples, a plurality of unit cells 132 as explained above with reference to FIG. 3B are integrated in a multi-layer stack comprising the carrier 132b. In some examples, one or more further layers 132e, 132f, for example, comprising dielectric material, may be provided, in which the plurality 142 of electrically conductive strips of the second isolation structure 140 may be arranged, either in the form of a single layer of strips, as depicted by FIG. 18, or in the form of multiple layers of strips (not shown in FIG. 18, see, for example, FIG. 7). In some examples, this enables to maintain a precise distance between the isolation structures 130, 140 and to attain a particularly low-profile isolation arrangement 130, 140.

In some examples, FIGS. 16, 17, wherein, for example, a common support structure 102 for at least two components 110, 120 is provided, for example, a common support structure 102 for the first antenna system 110 and the second antenna system 120, at least one of the first isolation structure 130 and the second isolation structure 140 may be provided on the common support structure 102, too.

As already mentioned above, in some examples, see FIGS. 16, 17, a radome 152′ may be provided, the radome 152′, for example, covering at least one component 110, 120, 130, 140 of the apparatus 100, such as, for example, at least one of the antenna systems 110, 120, and/or at least a portion of the first isolation structure 130. In some examples, the second isolation structure 140 may be arranged on the radome, for example, on an interior surface (FIGS. 16, 17) and/or an outer surface (not shown) of the radome.

In some other examples, however, it is also possible to arrange the second isolation structure at least partly within the radome, for example, by using a molded interconnected device manufacturing technique, wherein the electrically conductive strips 142a, 142b, . . . may be molded into the radome material.

In some examples, FIG. 18, an aggregated height h of the first isolation structure 130 and the second isolation structure 140 is less than 10 millimeters, mm, for example less than about 5 mm. In some examples, this enables to provide a particularly low-profile aggregated isolation structure 130, 140.

Some examples, FIG. 19, relate to a device 10 for a wireless communication system comprising at least one apparatus 100 according to the disclosure.

In some examples, FIG. 19, the device 10 may, for example, comprise or represent at least one of: a) base station, for example, eNB or gNB, or b) an access node, or c) a router, or d) a remote radio head.

In some other examples (not shown), however, the device 10 may, for example, comprise or represent at least one of: a) a terminal device, for example user equipment, for example smart phone or phone, or b) a laptop, or c) a tablet, or d) audio/video (A/V) equipment, or e) any other type of stationary and/or portable electronic device with wireless capability.

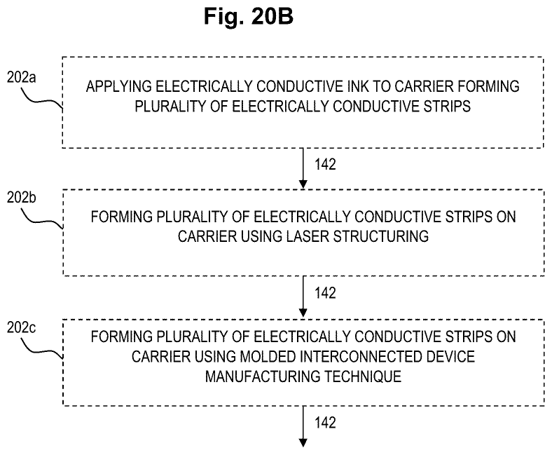

Some examples, FIG. 20A, relate to a method for providing an apparatus 100 comprising a first antenna system 110 and a second antenna system 120, the method comprising: providing 200 a first isolation structure 130 between the first antenna system 110 and the second antenna system 120 for suppressing a propagation of electromagnetic waves between the first antenna system 110 and the second antenna system 120, providing a 202 second isolation structure 140 between the first antenna system 110 and the second antenna system 120 for suppressing a propagation of electromagnetic waves between the first antenna system 110 and the second antenna system 120 by arranging the second isolation structure 140 at least partially over the first isolation structure 130.

In some examples, FIG. 20B, providing 202 (FIG. 20A) the second isolation structure 140 comprises at least one of: a) applying 202a (FIG. 20B) electrically conductive ink to a carrier 152 forming a plurality 142 of electrically conductive strips 142a, 142b, . . . on the carrier 152, or b) forming 202b a plurality 142 of electrically conductive strips 142a, 142b, . . . on the carrier 152 using laser structuring, or c) forming 202c a plurality 142 of electrically conductive strips on (or within) the carrier 152′ (FIGS. 16, 17) using a molded interconnected device, MID, manufacturing technique.

FIG. 21A depicts a simplified top view of a conventional apparatus 1 having two antenna systems 2, 3 and one single conventional RF isolation structure 4 of the EBG type arranged therebetween.

FIG. 21B depicts a simplified top view of an apparatus according to some examples, having a first antenna system 110, a second antenna system 120, a first isolation structure 130 and a second isolation structure 140, for example, at least similar to the configuration of FIG. 1 or 2.

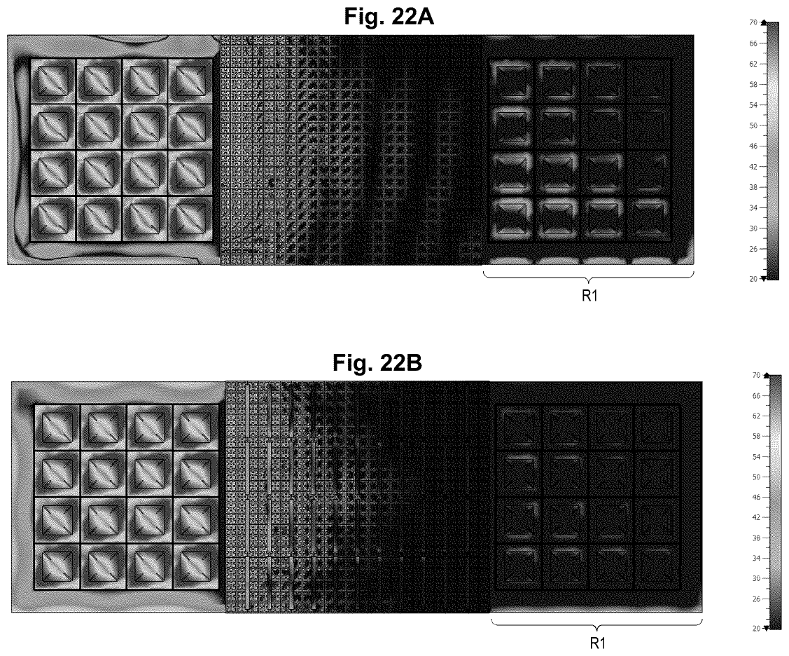

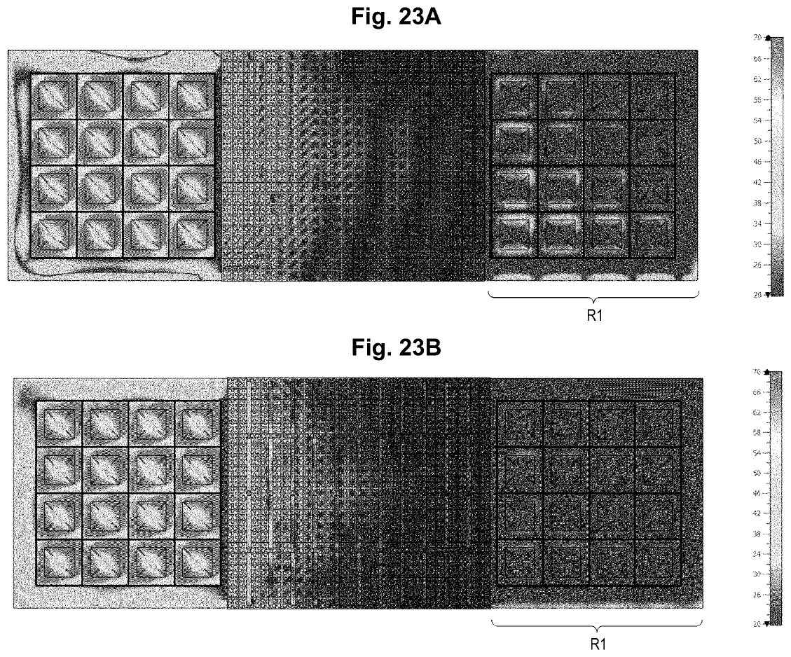

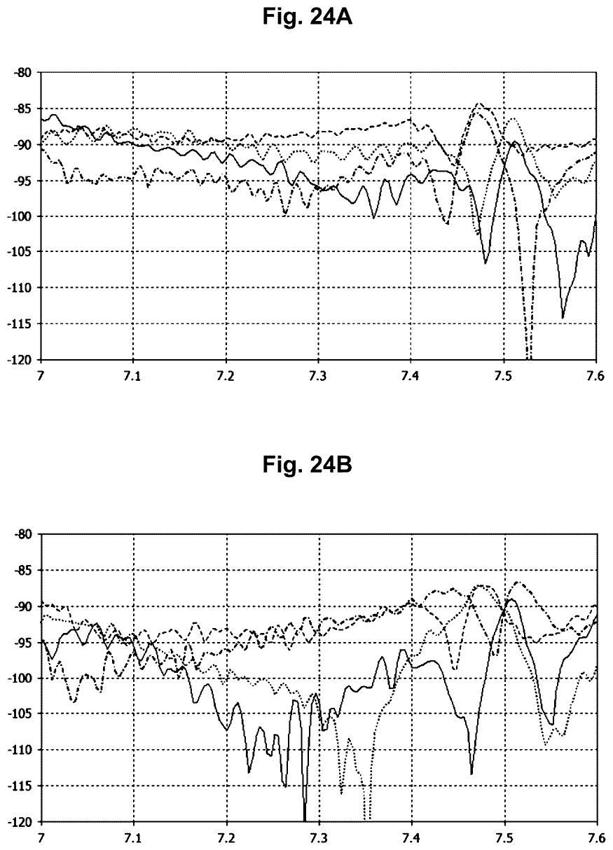

FIG. 22A depicts a colour illustration of an electric field strength for the conventional apparatus 1 of FIG. 21A, i.e., an electric field strength on a surface of the conventional apparatus 1 when the first antenna system 2 is excited by a −45° polarization at a carrier frequency of the first antenna system 2. It can be seen that in the region R1 of the second antenna system 3 of the conventional apparatus 1, a substantial electric field strength occurs, indicating an insufficient electromagnetic isolation between the first antenna system 2 and the second antenna system 3 when using the conventional RF isolation structure 4 (FIG. 21A). FIG. 23A represents a black and white version of FIG. 22A.

FIG. 22B depicts a colour illustration of an electric field strength for the apparatus according to the disclosure of FIG. 21B, i.e., an electric field strength on a surface of the apparatus 100 when the first antenna system 110 is excited by a −45° polarization at a carrier frequency of the first antenna system 110, i.e., similar to the excitation of the conventional apparatus 1, see FIGS. 21A, 22A. From FIG. 22B, it can be seen that, for the apparatus according to the disclosure, in the region R1 of the second antenna system 120, significantly weaker electric field components occur (as compared to FIG. 22A), indicating an improved electromagnetic isolation between the first antenna system 110 and the second antenna system 120 when using the aggregated RF isolation structure 130, 140 according to the disclosure (FIG. 21B). In other words, in the region R1 of the apparatus according to the disclosure, most of the radio frequency energy is suppressed by the RF isolation structures 130, 140, compared to region R1 (FIG. 22A) of the conventional apparatus 1. FIG. 23B represents a black and white version of FIG. 22B.

FIG. 24A depicts a magnitude of scattering parameters s21, s31, s41, s51 associated with co-polar couplings between the antenna systems 110, 120 of the apparatus of FIG. 21B over a frequency in GHz according to some examples.

Similarly, FIG. 24B depicts a magnitude of scattering parameters s61, s71, s81, s91 associated with cross-polar couplings between the antenna systems 110, 120 of the apparatus of FIG. 21B over frequency according some examples.

From FIGS. 24A, 24B it can be seen, that, using the apparatus according to the disclosure, even for the worst-case scenario associated with the cross-polar couplings (FIG. 24A), a comparatively high electromagnetic isolation of, for example, about −85 dB or better can be attained throughout the considered frequency range.

In the following, further aspects and examples are disclosed, which, in some examples, may be combined with at least one of the aspects and/or examples disclosed above.

In some examples, the apparatus 100 according to the disclosure may be used for sub-band full-duplex (SBFD) communication, which can, for example, be used as a method to improve uplink capacity of mobile communications, for example, in systems based on or according to 3GPP 6G. In SBFD, in some examples, an operation frequency band of an antenna system or antenna may be split, for example, during certain time slots, into simultaneously operating uplink (UL) and downlink (DL) sub-bands so that, in some examples, a frequency difference between the uplink and downlink bands may be too narrow for implementing sufficient RF filtering, for example, to isolate the uplink and downlink directions from each other, when using conventional filtering approaches. Therefore, physically separate antenna systems or panels 110, 120 (FIG. 1), for example, according to the disclosure, may be used for UL and DL during these time slots. In some examples, a comparatively high electromagnetic isolation may be attained between the antenna systems 110, 120 using the isolation structures 130, 140 according to the disclosure.

In some examples, in addition to the isolation structures 130, 140 according to the disclosure, which represent passive devices, one or more active interference cancellation techniques may be used which may, for example, provide for actively injecting a self-interference cancelation (SIC) signal, for example, into a receiving signal path.

In some examples, the principle according to the disclosure may be applied to any apparatus comprising two or more antenna systems 110, 120, for example, arranged close to each other (for example, within a range of 10 percent of a wavelength up to several wavelengths or several ten wavelengths), for example, sharing a same mechanical platform, such as, for example, a common carrier 102 (FIG. 2). In other words, the principle according to the disclosure is not limited to apparatus comprising two antenna systems 110, 120.

In some examples, the isolation structures 130, 140 may be planar structures, meaning they extend primarily in two dimensions with a limited thickness (for example, along the surface normal vector nv of the carrier 102, see FIG. 15) relative to their length and width. In some examples, such planar structures may, for example, comprise at least one of a) thin layers, or b) sheets, or c) patterned surfaces formed from dielectric, conductive, or composite materials.

In some examples, the isolation structures 130, 140 are comparatively thin, which may enable to avoid increasing an overall profile thickness of the apparatus 100.

In some examples, the isolation structures 130, 140 according to the disclosure enable to efficiently suppress not only a surface wave and an E-plane coupling, but also an H-plane coupling between the antenna systems 110, 120, for example, simultaneously. In other words, in some examples, providing the second isolation structure 140 according to the disclosure enables to efficiently suppress H-plane coupling without sacrificing an efficiency of the first isolation structure 130 in suppression of, for example, surface waves and E-plane coupling.

In some examples, FIG. 15, the isolation structures 130, 140 according to the disclosure may be implemented using at least one printed circuit board (PCB). As an example, a first PCB, for example, a two-layer PCB, may be used to provide the first isolation structure 130, also see FIGS. 3A, 3B. In some examples, a second PCB having at least one layer may be used to provide the second isolation structure 140 (FIG. 4). In some examples, a height of the entire aggregated isolation structure comprising the first isolation structure 130 and the second isolation structure 140 arranged at least partially over the first isolation structure 130 is, for example, only, about 5 mm.

In some examples, the principle according to the disclosure may be combined with further RF isolation and/or suppression techniques, such as, for example, at least one of a) beamforming, or b) beam nulling, c) absorber(s), and optionally, other techniques such as, for example, actively injecting a self-interference cancelation (SIC) signal, which in some examples may enable to use sub-band full-duplex communication.

In some examples, the principle according to the disclosure may be used for (in-band) full-duplex (FD) communication.

1. An apparatus comprising a first antenna system, a second antenna system, a first isolation structure arranged between the first antenna system and the second antenna system for suppressing a propagation of electromagnetic waves between the first antenna system and the second antenna system, and a second isolation structure arranged between the first antenna system and the second antenna system for suppressing a propagation of electromagnetic waves between the first antenna system and the second antenna system, wherein the second isolation structure is arranged at least partially over the first isolation structure,
wherein the second isolation structure comprises a plurality of strips of electrically conductive material, and
wherein at least some of the strips are oriented at an angle of 30 degrees or more relative to a longitudinal axis along which both antenna systems are positioned.

2. The apparatus according to claim 1, wherein the first isolation structure is an electronic band gap, EBG, structure.

3. The apparatus according to claim 1, wherein the first isolation structure is a) arranged on a surface of a support structure or b) at least partially integrated into the support structure.

4. The apparatus according to claim 1, wherein at least some of the plurality of strips are oriented at an angle of 45 degrees or more relative to the longitudinal axis.

5. The apparatus according to claim 1, wherein at least some of the strips are straight.

6. The apparatus according to claim 1, wherein the second isolation structure comprises at least two layers, each of the at least two layers comprising a respective plurality of strips of electrically conductive material.

7. The apparatus according to claim 1, wherein at least some of the strips are curved.

8. The apparatus according to claim 7, wherein at least some of the strips comprise a plurality of curved sections with at least two different radii of curvature.

9. The apparatus according to claim 1, wherein at least some of the strips comprise a length of 50 percent of a free-space wavelength of the electromagnetic waves or less.

10. The apparatus according to claim 1, wherein at least two of the strips are collinear and spaced apart by a first distance.

11. The apparatus according to claim 1, wherein a distance between the first isolation structure and the second isolation structure is less than 33 percent of a wavelength of the electromagnetic waves.

12. The apparatus according to claim 1, wherein at least one of the first antenna system or the second antenna system is a dual-polarized antenna system.

13. The apparatus according to claim 1, wherein the first isolation structure and the second isolation structure are configured to jointly reduce an H-plane coupling and an E-plane coupling between the first antenna system and the second antenna system.

14. The apparatus according to claim 1, wherein a) the first isolation structure is provided on a first carrier and the second isolation structure is provided on a second carrier, or wherein b) the first isolation structure and the second isolation structure are both provided on a same carrier.

15. The apparatus according to claim 14, when a) the first isolation structure is provided on a first carrier and the second isolation structure is provided on a second carrier, a first layer of the at least two layers is formed on a first surface of the carrier, and a second layer of the at least two layers is formed on a second, opposite, surface of the carrier.

16. The apparatus according to claim 1, comprising a radome, wherein the second isolation structure is arranged on or at least partly arranged within the radome.

17. The apparatus according to claim 1, wherein an aggregated height of the first isolation structure and the second isolation structure is less than 10 millimeters.

18. A device for a wireless communication system comprising at least one apparatus according to claim 1.

19. A method for providing an apparatus comprising a first antenna system and a second antenna system, the method comprising: providing a first isolation structure between the first antenna system and the second antenna system for suppressing a propagation of electromagnetic waves between the first antenna system and the second antenna system, providing a second isolation structure between the first antenna system and the second antenna system for suppressing a propagation of electromagnetic waves between the first antenna system and the second antenna system by arranging the second isolation structure at least partially over the first isolation structure,
wherein the second isolation structure comprises a plurality of strips of electrically conductive material, and
wherein at least some of the strips are oriented at an angle of 30 degrees or more relative to a longitudinal axis along which both antenna systems are positioned.

20. The method of claim 19, wherein providing the second isolation structure comprises at least one of: a) applying electrically conductive ink to a carrier forming a plurality of electrically conductive strips on the carrier, or b) forming a plurality of electrically conductive strips on the carrier using laser structuring, or c) forming a plurality of electrically conductive strips on the carrier using a molded interconnected device, MID, manufacturing technique.
